(19) United States
(12) Patent Application Publication
(10) Pub. No.: US 2025/0157698 A1
(43) Pub. Date: May 15, 2025

(54) WIRE HARNESS MANUFACTURING APPARATUS

(71) Applicant: Yazaki Corporation, Tokyo (JP)

(72) Inventors: Hiroyasu KOBAYASHI, Makinohara-shi (JP); Yukihiro Sugihara, Makinohara-shi (JP); Jun Yagi, Makinohara-shi (JP); Takahito Fujikawa, Makinohara-shi (JP)

(73) Assignee: Yazaki Corporation, Tokyo (JP)

(21) Appl. No.: 18/910,027

(22) Filed: Oct. 9, 2024

(30) Foreign Application Priority Data
Nov. 13, 2023 (JP) 2023-192697

(51) Int. Cl. H01B 13/012; B25J 11/00

(52) U.S. Cl. CPC H01B 13/01236; B25J 11/005

(57) ABSTRACT

A wire harness manufacturing apparatus includes a plurality of sliding portions provided at a position at a predetermined height to line up along an arrangement direction being parallel to each other to perform a movement in a straight line along a sliding direction between a first-end side and a second-end side, one or more base-end retaining portions provided at the first-end side at the predetermined height to be immobile at least in the sliding direction, the base-end retaining portion being lined up in the arrangement direction to retain the other end side of at least one of the electric wire toward the reference surface side; and an electric-wire processing portion performing an electric-wire processing of selectively bundling the electric wires to form the branch shape with respect to the plurality of electric wires that are stretched between the one or more base-end retaining portions and the plurality of sliding portions.

### TECHNICAL FIELD

The present disclosure relates to a wire harness manufacturing apparatus and a wire harness manufacturing method for manufacturing a branch shape wire harness.

### BACKGROUND ART

Conventionally, an apparatus in which multiple holding members for holding wire harnesses are arranged on a flat wiring board in accordance with a branch shape has been used as a manufacturing apparatus for manufacturing a branched-shape wire harness (for example, see Patent Document 1). In this type of manufacturing apparatus, wire harnesses are manufactured by routing electric wires on the wiring board and forming the branch shape.

### CITATION LIST

### Patent Documents

[Patent Document 1] JP 2018-060643A

### SUMMARY OF THE INVENTION

### Technical Problem

Most of the tasks using the above-described manufacturing apparatus are performed manually by operators. On the other hand, development of an apparatus that automatically performs manufacturing task without human intervention for manufacturing the wire harnesses is also underway. However, according to the automatic manufacturing, there is a problem such as the wires that are being manufactured getting caught in various portions of the apparatus and thus stopping the work, thus making the equipment development difficult.

Accordingly, the present invention has focused on the above-identified problem and an object of the present disclosure is to provide a wire harness manufacturing apparatus that can automatically manufacture a wire harness while preventing the electric wires from being caught during the manufacturing process.

### Solution to Problem

In order to solve the above-identified problem, a wire harness manufacturing apparatus is characterized by including a plurality of sliding portions provided at a position at a predetermined height from a reference surface extending along a horizontal surface, the plurality of sliding portions each retaining one end side of at least one electric wire, configuring a wire harness having a branch shape, toward the reference surface side, and the plurality of sliding portions being configured to line up along an arrangement direction in the reference surface to be parallel to each other to perform a movement in a straight line along a sliding direction between a first-end side and a second-end side; one or more base-end retaining portions provided at the first-end side as a base-end side of the movement in a straight line at the predetermined height to be immobile at least in the sliding direction, the base-end retaining portion being lined up in the arrangement direction to retain the other end side of at least one of the electric wire toward the reference surface side; and an electric-wire processing portion as a mechanism portion configured to perform an electric-wire processing including a processing of selectively bundling the electric wires to form the branch shape with respect to the plurality of electric wires that are stretched between the one or more base-end retaining portions and the plurality of sliding portions by the plurality of sliding portions, each retaining the one end side of the electric wire, moving to a position in response to the branch shape between the first-end side and the second-end side, wherein the electric-wire processing portion is provided to not in contact with the electric wire even in a case in which the electric wire hangs downward due to the position of the sliding portion.

### Effect of the Invention

According to the above-described wire harness manufacturing apparatus, it is possible to automatically manufacture a wire harness while preventing the electric wires from being caught during the manufacturing process.

### BRIEF DESCRIPTION OF THE DRAWINGS

FIG. 1 is a schematic external perspective view showing a wire harness manufacturing apparatus according to an embodiment.

FIG. 2 is a schematic planar view showing a sliding portion, a base-end retaining portion, and peripheral structure thereof in the wire harness manufacturing apparatus shown in FIG. 1.

FIG. 3 is a schematic view showing an example of a wire harness that is manufactured by the wire harness manufacturing apparatus shown in FIG. 1 and FIG. 2.

FIG. 4 is a schematic planar view showing a sub-harness supply cart shown in FIG. 1 viewed from an arrow V11 direction in FIG. 1.

FIG. 5A is a schematic view showing, in the wire harness manufacturing apparatus shown in FIG. 1 to FIG. 4, a state of supplying the sub-harness from the sub-harness supply cart.

FIG. 5B is a schematic view showing, in the wire harness manufacturing apparatus shown in FIG. 1 to FIG. 4, a state of unloading the wire harness after the manufacturing process is finished.

FIG. 6 is a schematic view similar to FIG. 3 to show another example of the wire harness as the manufacturing target of the wire harness manufacturing apparatus shown in FIG. 1.

FIG. 7A is a schematic view showing an exterior installation plate used for accommodating the electric wires with respect to a protector main body shown in FIG. 6.

FIG. 7B is a schematic view showing an exterior installation plate used for accommodating the electric wires with respect to a protector main body shown in FIG. 6.

FIG. 8 is a schematic view showing an electric-wire guide used for accommodating the electric wires with respect to the protector main body together with the exterior installation plate shown in FIG. 7A and FIG. 7B.

### DESCRIPTION OF EMBODIMENTS

Hereinafter, an embodiment of a wire harness manufacturing apparatus will be described.

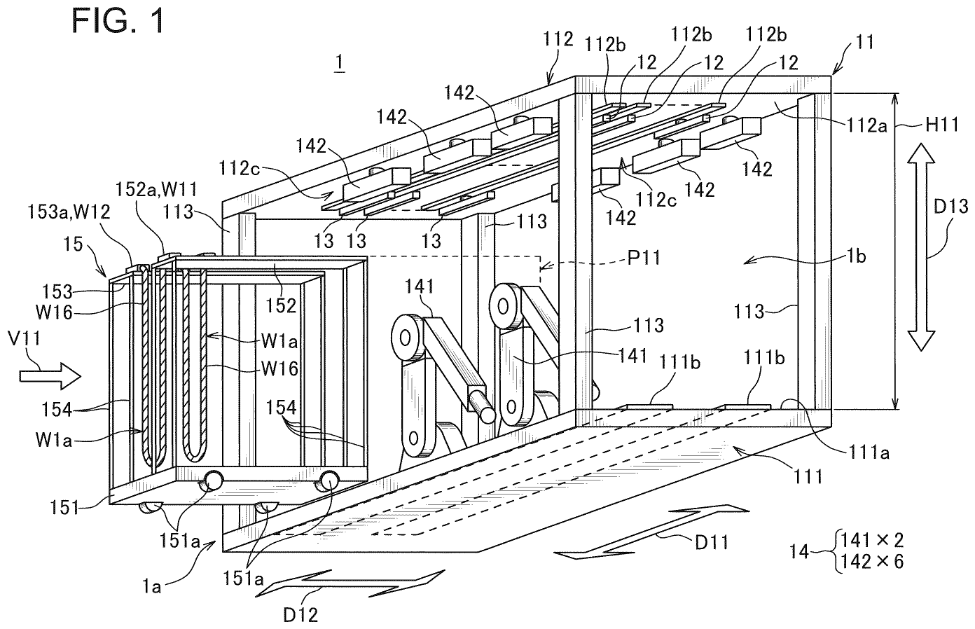

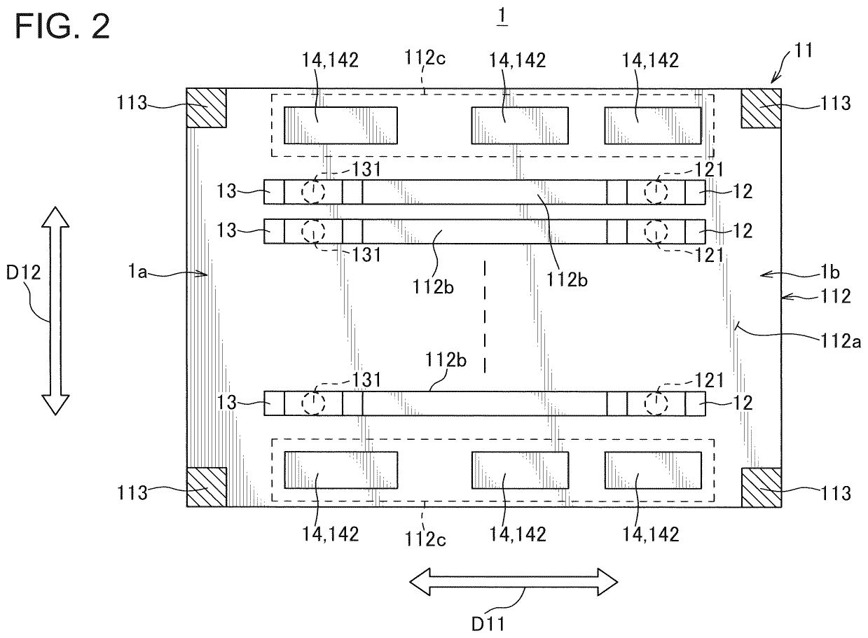

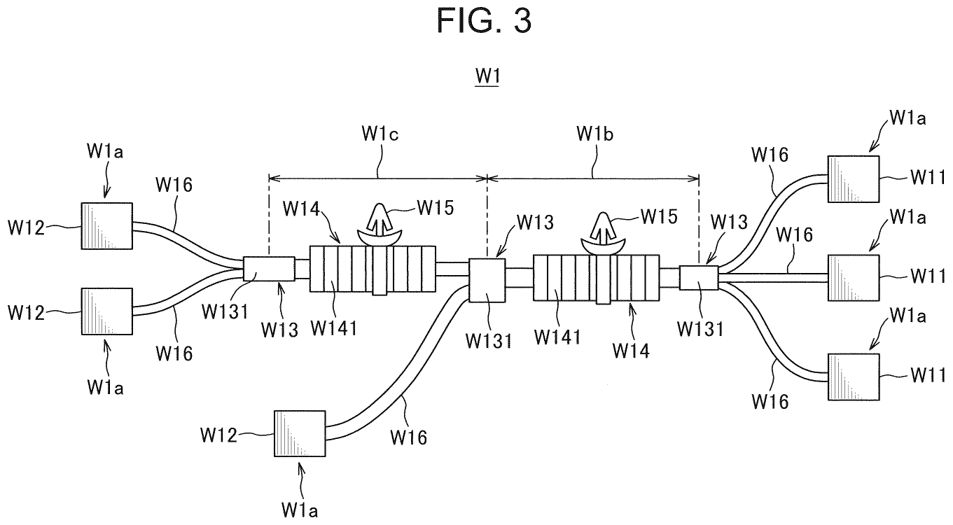

FIG. 1 is a schematic external perspective view showing a wire harness manufacturing apparatus according to an embodiment, and FIG. 2 is a schematic planar view showing a sliding portion, a base-end retaining portion, and peripheral structure thereof in the wire harness manufacturing apparatus shown in FIG. 1. FIG. 3 is a schematic view showing an example of a wire harness that is manufactured by the wire harness manufacturing apparatus shown in FIG. 1 and FIG. 2.

A wire harness manufacturing apparatus 1 according to the present embodiment is an apparatus configured to automatically manufacture a wire harness W1 in a branch shape as the example shown in FIG. 3.

The wire harness W1 as a manufacturing target is mounted and routed in a vehicle so as to connect multiple devices inside the vehicle. This wire harness W1 includes a plurality of front-end connectors W11, a plurality of back-end connectors W12, a plurality of tape winding portions W13, a plurality of exterior portions W14, and a plurality of fixing clips W15.

The front-end connector W11 is a connector being a front-end side of a movement as being moved in a sliding direction D11 while being retained by a sliding portion 12 in the wire harness manufacturing apparatus 1 that is described below. On the other hand, the back-end connector W12 is a connector being a base-end side that is immobile in the sliding direction D11 while being retained by a base-end retaining portion 13 described below. Here, according to the present embodiment, the wire harness W1 as the manufacturing target is configured by combing a plurality of sub-harness W1a that is configured by one or more electric wires W16, wherein both end portions of this electric wire W16 are configured by the front-end connector W11 and the back-end connector W12. This combination is performed by formations of the tape winding portion W13 and the exterior portion W14, and an attachment of the fixing clip W15.

The tape winding portion W13 is a portion where the electric wires W16 of the plurality of sub-harnesses W1a are selectively bundled to be wound by a tape W131. In an example shown in FIG. 3, at first, the tape winding portions W13 are formed at both end portions of a main wire portion W1b where the electric wires W16 of all of the sub-harnesses W1a are bundled. The main wire portion W1b is bifurcated into two branches and then further bifurcated into two branches at the side of the back-end connector W12, however, the tape winding portion W13 is also formed in an end portion at the side of the back-end connector W12 in an intermediate wire portion W1c that is sandwiched between both branches. The exterior portion W14 is formed at two portions including a portion where the electric wires W16 of the main wire portion W1b are accommodated in a corrugated tube W141 and a portion where the electric wires W16 of the intermediate wire portion W1c are accommodated in the corrugated tube W141. The fixing clip W15 is a component for engaging and fixing the wire harness W1 to a predetermined fixing destination, and in the example shown in FIG. 3, the fixing clips W15 are attached to the exterior portions W14 at the two locations.

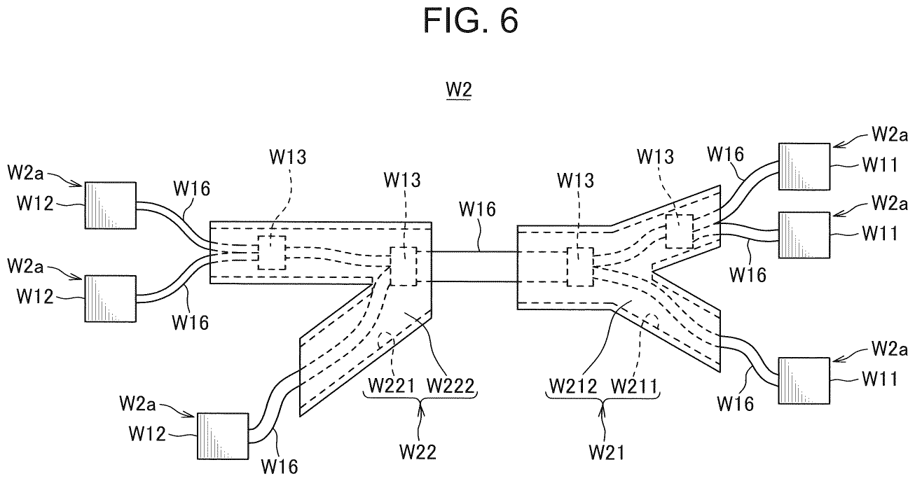

The wire harness manufacturing apparatus 1 shown in FIG. 1 and FIG. 2 is the apparatus to automatically manufacture the wire harness W1 described above, and includes an apparatus frame 11, a sliding portion 12, a base-end retaining portion 13, and an electric-wire processing portion 14. The wire harness manufacturing apparatus 1 also includes a sub-harness supply cart 15, and an exterior installation plate 16 together with an electric-wire guide portion 17 described below by referring to FIG. 6 to FIG. 8 as components that are suitably retrofitted to the apparatus frame 11 and configured.

The apparatus frame 11 is a portion for retaining each portion of the wire harness manufacturing apparatus 1, and includes a bottom-plate portion 111, a ceiling-plate portion 112, and a column portion 113. The bottom-plate portion 111 and the ceiling-plate portion 112 are rectangular plate-shaped members in the same shape, wherein the corner portions thereof are connected to each other by four column portions 113 in a square column shape.

The bottom-plate portion 111 includes an upper surface thereof as a reference surface 111a in the wire harness manufacturing apparatus 1, and it is a member being placed at a predetermined installation location such that this reference surface 111a extends along the horizontal surface. In the reference surface 111a, a corner portion thereof is connected by a lower-end portion of the column portion 113, and two arm rails 111b are formed such that two robot arms 141 described below perform movements along a straight line in the sliding direction D11 along a long side of the rectangular reference surface 111a. Each arm rail 111b is provided such that each robot arm 141 performs the movement along the straight line between a first-end side 1a and a second-end side 1b in the sliding direction D11 in the wire harness manufacturing apparatus 1. Then, two of the arm rails 111b are provided such that two robot arms 141 perform the movement along the straight line in a parallel manner with respect to each other in an arrangement direction D12 along the short side of the reference surface 111a.

The ceiling-plate portion 112 includes a lower surface thereof as a ceiling surface 112a where the sliding portion 12 and the like are disposed, and it is a member being placed such that this ceiling surface 112a is positioned at a predetermined ceiling height H11 from the reference surface 111a of the bottom-plate portion 111 while facing the reference surface 111a. In this ceiling surface 112a, a corner portion thereof is connected by an upper-end portion of the column portion 113, and a plurality of sliding rails 112b are formed such that the plurality of sliding portions 12 perform the movement in a straight line in the sliding direction D11 along the long side of the rectangular ceiling surface 112a. Each sliding rail 112b is provided such that each sliding portion 12 performs the movement in a straight line between the first-end side 1a and the second-end side 1b of the wire harness manufacturing apparatus 1. Then, such sliding rails 112b are provided in a plural such that the plurality of sliding portions 12 perform the movement in a straight line in a parallel manner with respect to each other in the arrangement direction D12 along the short side of the ceiling surface 112a. Also, in the arrangement direction D12, an area in proximity to a pair of side edges being adjacent to the outside of the plurality of sliding portions 12 becomes a standby location for a processing mechanism 142 described below to be selectively retained by the robot arm 141. Each standby location 112c is an area where every three of the processing mechanism 142 stand by while being lined up in the sliding direction D11.

As described above, the column portion 113 is formed as four corner columns to connect the corner portions of the reference surface 111a in the bottom-plate portion 111 and the corner portions of the ceiling surface 112a n the ceiling-plate portion 112 in the up-down direction D13. A length of each column portion 113 is a length to cause the ceiling surface 112a to be positioned above the predetermined ceiling height H11 from the reference surface 11a. This ceiling height H11 is the height to make the electric wire W1a not to contact the reference plane 111a when the electric wire W1a hangs down to the maximum expected length during the manufacture of the wire harness W1 in the wire harness manufacturing apparatus 1.

The apparatus frame 11 in which the bottom-plate portion 111 and the ceiling-plate portion 112 are connected by the four column portions 113 generally has a rectangular parallelepiped frame structure with the side surfaces to be open, and the manufacture of the wire harness W1 is performed in the ceiling surface 112a at the internal side thereof. Here, the manufacture of the wire harness W1 is performed by a retaining of the electric wire end portions by the sliding portion 12 and the base-end retaining portion 13, and an electric wire processing including branch formation by the electric-wire processing portion 14.

The sliding portions 12 are attached to the plurality of sliding rails 112b of the ceiling surface 112a one by one so as to be rotatable around a rotation axis 121. Then, the sliding portions 12 perform the movement in a straight line on the sliding rails 112b between the first-end side 1a and the second-end side 1b in the sliding direction D11 while being lined up parallelly to each other in the arrangement direction D12. Each sliding portion 12 is a member to retain the front-end connector W11 of the above-mentioned sub-harness W1a one by one so as to be openable toward the reference surface 111a side. The sliding portion 12 retains one end of at least one electric wire W16 via the front-end connector W11, that is, the electric wires W16 with the number to which the front-end connectors W11 are connected, so as to be openable toward the reference surface 111a.

The base-end retaining portion 13 is a member provided at the first-end side 1a as the base end side of the sliding movement of the sliding portion 12 in the ceiling surface 112a so as to be immobile in the sliding direction D11. One or more base-end retaining portions 13 are lined up at the first-end side 1a in the arrangement direction D12 while each being rotatable around the rotation axis 131. Here, according to the present embodiment, the base-end retaining portions 13 are fixedly disposed at the first-end side 1a in the plurality of sliding rails 112b respectively. That is, the plurality of sliding portions 12 are configured to face the plurality of base-end retaining portions 13 one by one to perform the movement in the straight line. Each base-end retaining portion 13 is the member to retain the back-end connector W12 in the sub-harness W1a one by one so as to be openable toward the reference surface 111a side. The base-end retaining portion 13 retains the other end of at least one electric wire W16 via the back-end connector W12, that is, the electric wires W16 with the number to which the back-end connectors W12 are connected, so as to be openable toward the reference surface 111a.

According to the wire harness manufacturing apparatus 1, the front-end connectors W11 of the plurality of sub-harnesses W1a are retained by the sliding portion 12, and the back-end connectors W12 thereof are retained by the base-end retaining portion 13, respectively. Thereafter, by moving the sliding portion 12 retaining the front-end connectors W11 to a position corresponding to the branch shape of the wire harness W1 as the formation target, the plurality of electric wires W16 are stretched between the plurality of base-end retaining portions 13 and the plurality of sliding portions 12. At this time, in the example shown in FIG. 3, in the wire harness W1, the number of the front-end connectors W11 and the number of the back-end connectors W12 are the same with each other such that the electric wires W16 are stretched between the plurality of base-end retaining portions 13 and the plurality of sliding portions W12 having the same number. However, the wire harness as the formation target is, of course, not limited to the example shown in FIG. 3, for example, an aspect in which the back-end connector is one and the front-end connectors are in a plural may be implemented. Alternatively, the wire harness may be configured to have the back-end connectors in a plural and the front-end connectors with a number different from that of the back-end connectors, that is, more or less than the number of the back-end connectors. In such cases, the plurality of sliding portions and one or more base-end retaining portions 13 are selected corresponding to the numbers of the front-end connectors and the back-end connectors in the wire harness as the formation target, and the retaining of the end portions of the electric wires W16 are performed via each connector. Then, after the movement of the sliding portion 12, the plurality of electric wires W16 are stretched between the one or more base-end retaining portions 13 and the plurality of sliding portions 12. Thereafter, the electric wire processing is performed by the electric-wire processing portion 14 with respect to the electric wires W16 being stretched between the base-end retaining portions 13 and the sliding portions 12.

The electric-wire processing portion 14 is a mechanism configured to perform the electric wire processing including the processing to selectively bundle the plurality of electric wires W16, which are stretched between the base-end retaining portions 13 and the sliding portions 12, to form the branch shape by each sliding portion 12 moving to the position corresponding to the branch shape. Then, the electric-wire processing portion 14 is provided so as to not to be in contact with the electric wire W16 even when the electric wire W16 hangs down due to the position of the sliding portion 12. This electric-wire processing portion 14 includes two robot arms 141 and six processing mechanism 142.

As described above, the robot arm 141 is an articulated robot attached to the arm rail 111b provided on the reference surface 111a of the bottom plate portion 111 so as to move in a straight line in the sliding direction D11. The robot arm 141 retains one processing mechanism 142 being exchangeable with other processing mechanism 142 at the front end thereof to transport to a workplace of the electric wire processing.

The processing mechanism 142 is the mechanism being detachably retained by the robot arm 141 and being carried to the workplace of the electric wire processing to perform the electric wire processing. Also, as described above, until being retained by the robot arm 141, the processing mechanism 142 stands by in the standby location being adjacent to the sliding rail 112b as the movement route of the sliding portion 12 in the ceiling surface 112a. According to the present embodiment, the standby locations are provided at two locations near a pair of sides in the rectangular ceiling surface 112a, and three processing mechanism 142 are provided in each standby location 112c. The three of processing mechanism 142 in each standby location 112c are mechanism corresponding to three types of electric wire processing one by one performed to the electric wires W16. That is, the first processing mechanism 142 is the mechanism to perform winding of the tape W131, the second processing mechanism 142 is the mechanism to perform attachment of the corrugated tube W141, and the third processing mechanism 142 is the mechanism to perform attachment of the fixing clip W15. Between the standby locations 112c at the two locations, the processing mechanism 142 in the same type are provided.

According to the electric-wire processing portion 14, the two robot arms 141 correspond to the standby locations 112c at two locations one by one, and each robot arm 141 selectively retains one processing mechanism 142 corresponding to the processing content to be performed among the three types of processing mechanism 142 at the corresponding standby locations 112c. Thereafter, the robot arm 141 moves on the arm rail 111b to the position corresponding to the workplace to transport the processing mechanism 142 to the workplace to perform the operation. At the time of perform other operations, the robot arm 141 moves on the arm rail 111b to perform the exchange of the processing mechanism 142 in the standby location 112c and transports the exchanged processing mechanism 142 to the corresponding workplace to perform the operation. Also, during the operation, in a case in which the electric wire W16 hangs down, the robot arm 141 moves on the arm rail 111b to a position where it does not come into contact with the electric wire W16 and performs the operation while avoiding the electric wire W16.

The supply of the plurality of sub-harnesses W1a to the wire harness manufacturing apparatus 1 performing operations in such manner is performed by using the sub-harness supply cart 15.

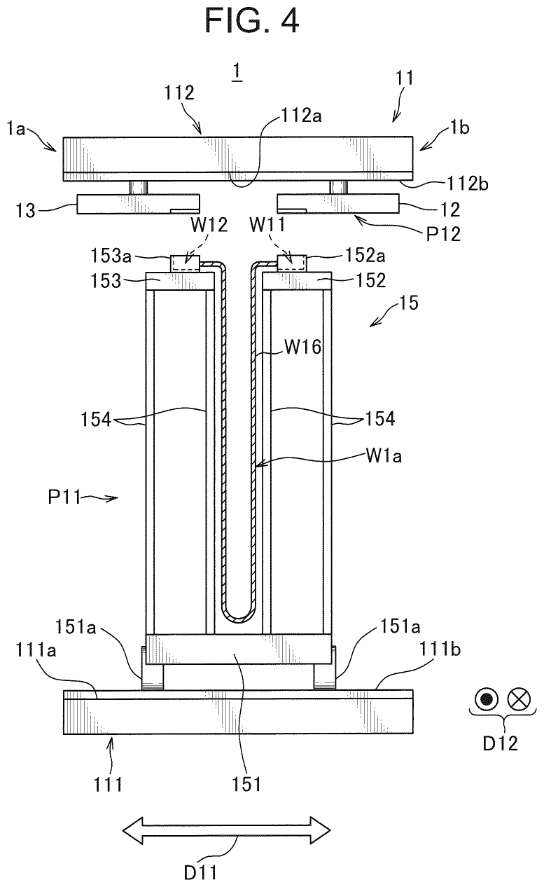

FIG. 4 is a schematic planar view showing the sub-harness supply cart shown in FIG. 1 when viewed from the arrow V11 direction in FIG. 1.

The sub-harness supply cart 15 is a cart that can be taken in and out along the reference surface 111a to a supply position P11 between the reference surface 111a and the plurality of sliding portions 12 and the one or more base-end retaining portions 13 while retaining the plurality of sub-harnesses W1a. As described above, the apparatus frame 11 generally has the rectangular parallelepiped frame structure with side surfaces open. At the time of supplying the sub-harness W1a, as shown in FIG. 1, the sub-harness supply cart 15 is taken to the inside of the apparatus frame 11 from the open side surfaces along the arrangement direction D12 of the arm rail 111b and the sliding rail 112b. Also, at this time, the robot arm 141 retreats from the path of the sub-harness supply cart 15 so as not to obstruct the entrance of the sub-harness supply cart 15. Then, when the sub-harness supply cart 15 reaches the supply position P11, the front-end connectors W11 and the back-end connectors W12 of the retained plurality of sub-harnesses W1a are delivered from the sub-harness supply cart 15 to the sliding portion 12 and the base-end retaining portion 13 from the lower side. Due to this delivery, the sub-harnesses W1a are supplied between the sliding portion 12 and the base-end retaining portion 13.

This sub-harness supply cart 15 has a rectangular parallelepiped-shaped frame structure in which the arrangement direction D12 is a longitudinal direction when being inserted into the apparatus frame 11, and it includes a bottom plate portion with wheels 151, a front-end retaining ceiling plate portion 152, a back-end retaining ceiling plate 153, and a cart column portion 154.

The bottom plate portion with wheels 151 is a rectangular plate having four wheels 151a, and it travels on the reference surface 111a of the bottom-plate portion 111 in the apparatus frame 11 in the arrangement direction D12 when inserting the sub-harness supply cart 15.

The front-end retaining ceiling plate portion 152 is a rectangular plate to line up the front-end connectors W11 of the plurality of sub-harnesses W1a in a row in the arrangement direction D12 and detachably retain the front-end connectors W11 of the plurality of sub-harnesses W1a. On the upper surface of this front-end retaining ceiling plate portion 152, a plurality of front-end connector cups 152a are provided to line up in a row in the arrangement direction D12 to retain the front-end connectors W11 respectively. Each front-end connector cup 152a is open at the top side and at the lateral side facing the back-end retaining ceiling plate 153, the front-end connector W11 is taken in and out from the opening at the top side, and the opening at the lateral side is an extending open for the electric wire W16 when retaining the connector.

The back-end retaining ceiling plate 153 is a rectangular plate substantially the same with the front-end retaining ceiling plate portion 152, and on the upper surface thereof, a plurality of back-end connector cups 153a are provided to line up in a row in the arrangement direction D12. The back-end retaining ceiling plate 153 and the front-end retaining ceiling plate portion 152 are disposed to be parallel to each other to leave a gap therebetween for the electric wires W16 to hang down when retaining the connectors. The electric wires W16 of the sub-harness W1a extending from the back-end connector cups 153a and the front-end connector cups 152a hangs down downwardly toward the bottom plate portion with wheels 151 from the gap between the back-end retaining ceiling plate 153 and the front-end retaining ceiling plate portion 152 in a state of being bent in a U shape.

The cart column portion 154 are eight columns connecting the corner portions of the back-end retaining ceiling plate 153 and the front-end retaining ceiling plate portion 152 with the bottom plate portion with wheels 151. These eight cart column portions 154 are configured to support the back-end retaining ceiling plate 153 and the front-end retaining ceiling plate portion 152 such that they are parallel to each other to leave the gap for the passage of the electric wires W16 therebetween.

Here, according to the present embodiment, when delivering the front-end connectors W11 and the back-end connectors W12 from the sub-harness supply cart 15, the sliding portion 12 moves in the sliding direction D11 to the connector receiving position P12 at the first-end side 1a. On the other hand, in the sub-harness supply cart 15, the front-end connector cups 152a and the back-end connector cups 153a are arranged as follows. That is, the front-end connector cups 152a are arranged such that the front-end connectors W11 at the supply position P11 face the plurality of sliding portions 12 lining up in a row in the arrangement direction D12 at the connector receiving position P12 respectively. Similarly, the back-end connector cups 153a are arranged such that the back-end connectors W12 at the supply position P11 face the plurality of the one or more base-end retaining portions 13 lining up in a row in the arrangement direction D12 at the first-end side 1a respectively. As a result, during the stage when the sub-harness supply cart 15 is inserted until the supply position P11, the front-end connectors W11 and the back-end connectors W12 are positioned in a state of facing each other one by one immediately under the sliding portion 12 and the base-end retaining portion 13 in the ceiling-plate portion 112.

Thereafter, the sub-harness supply cart 15 ascends at the supply position P11 and presses the front-end connectors W11 and the back-end connectors W12 in the plurality of sub-harnesses W1a against the sliding portions 12 and the base-end retaining portions 13 in one-to-one correspondence to deliver them at once. After supplying the sub-harnesses W1a by this delivery, the sub-harness supply cart 15 descends and retreats from the apparatus frame 11 to the lateral side.

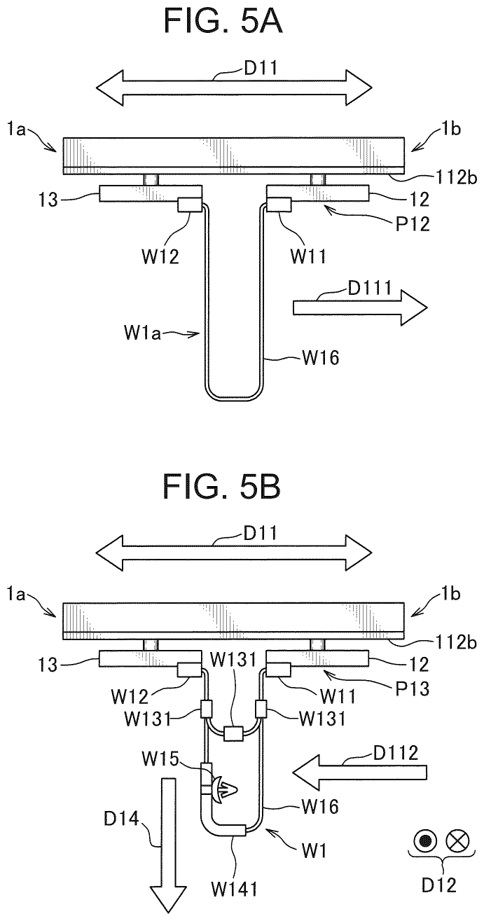

FIG. 5A and FIG. 5B are schematic views showing, in the wire harness manufacturing apparatus shown in FIG. 1 to FIG. 4, a state of supplying the sub-harness from the sub-harness supply cart and a state of unloading the wire harness after the manufacturing process is finished, respectively. In FIG. 5A and FIG. 5B, the two states at the time of supplying and at the time of unloading are shown in planar views from the lateral side similar to FIG. 4. In FIG. 5A, the state of supplying the sub-harness W1a is shown, and in FIG. 5B, the state of unloading the wire harness W1 is shown.

In the state at the time of supplying the sub-harness W1a, the front-end connectors W11 and the back-end connectors W12 are retained by the sliding portions 12 positioned at the connector receiving position P12 and the base-end retaining portion that is fixedly disposed at the first-end side 1a. In this state, the electric wire W16 hangs downward in the state of being bent into a U-shape while being retained in the sub-harness supply cart 15. Thereafter, the sliding portion 12 moves to the position in response to the branch shape along a stretching direction D111 being separated from the base-end retaining portion 13 to stretch the electric wires W16 in the sliding direction D11 such that the electric wire W16 is stretched between the base-end retaining portion 13 and the sliding portion 12. The electric wire processing with respect to this stretched electric wire W16 is performed, and the winding of the tape W131, the attachment of the corrugated tube W141 and the attachment of the fixing clip W15 are performed such that the wire harness W1 is manufactured.

In the unloading state of the wire harness W1 to which the electric wire processing by the electric-wire processing portion 14 has been performed, the plurality of sliding portions 12 move in a folding direction D112 to approach the base-end retaining portion 13 to fold the electric wires W16 in the sliding direction D1i. The movement in this folding direction D112 is performed such that the plurality of sliding portions 12 line up in a row in the arrangement direction D12 of the sliding rails 112b at the unloading position P13 at the first-end side 1a. According to the present embodiment, this unloading position P13 is the same with the connector receiving position P12 at the time of supplying the sub-harness W1a. Once a state in which all of the sliding portions 12 retaining the front-end connectors W11 reaches the unloading position P13 to line up in a row is realized, each sliding portion 12 releases the front-end connector W11 at this unloading position P13. Also, at this time, the base-end retaining portion 13 releases the back-end connector W12. By releasing these connectors, the wire harness W1 that has been processed by the electric wire processing falls due to its own weight toward an unloading direction D14 to be unloaded.

Here, according to the description up to this point, the wire harness W1 shown in FIG. 3 is shown as an example of the manufacturing target in the wire harness manufacturing apparatus 1. However, the manufacturing target in the wire harness manufacturing apparatus 1 is not limited thereto, and other examples shown as follows may be treated as the manufacturing target.

FIG. 6 is a schematic planar view similar to FIG. 3 to show another example of the wire harness as the manufacturing target of the wire harness manufacturing apparatus shown in FIG. 1. In this FIG. 6, the configuration elements being equivalent to the configuration elements shown in FIG. 3 are designated with the same reference signs as that in FIG. 3, and hereafter, the duplicate description of these equivalent configuration elements are omitted.

A wire harness W2 shown in this FIG. 6 as another example includes the plurality of front-end connectors W11, the plurality of back-end connectors W12, and the plurality of tape winding portions W13. Also, this wire harness W2 is configured by combining a plurality of sub harnesses W2a in which both end portions of the electric wire W16 are connected to the front-end connector W11 and the back-end connector W12. Then, according to the present embodiment, the electric wires 16 that are bundled in the branch shape by the tape winding portion W13 has a configuration that is accommodated in the two exterior members as the front-end protector W21 and the back-end protector W22. Either of the front-end protector W21 or the back-end protector W22 is an exterior member in a bifurcated cylindrical shape that is able to accommodate the electric wire W16 therein from a lateral side intersecting to a length direction and is configured by a groove-shaped protector main body W211 or W221, and a protector cover W212 or W222. The electric wire W16 is accommodated therein from the groove opening of the protector main body W211, W221 in a state in which the protector cover W212, W222 is removed, and thereafter, the protector cover W212, W222 is attached thereto. Here, according to the wire harness manufacturing apparatus 1 in the present embodiment, the accommodation of the electric wire W16 to the protector main body W211, W221 is performed by using the exterior installation plate 16 and the electric-wire guide portion 17 described below.

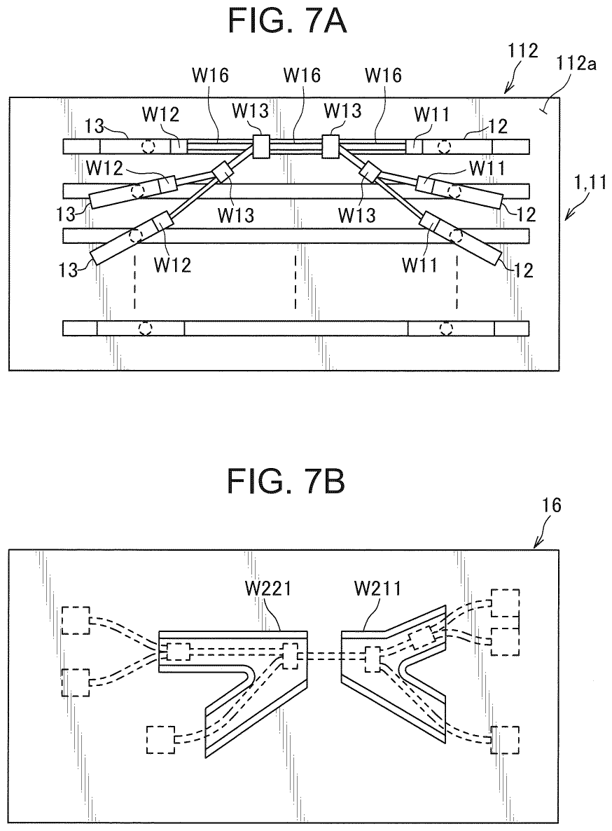

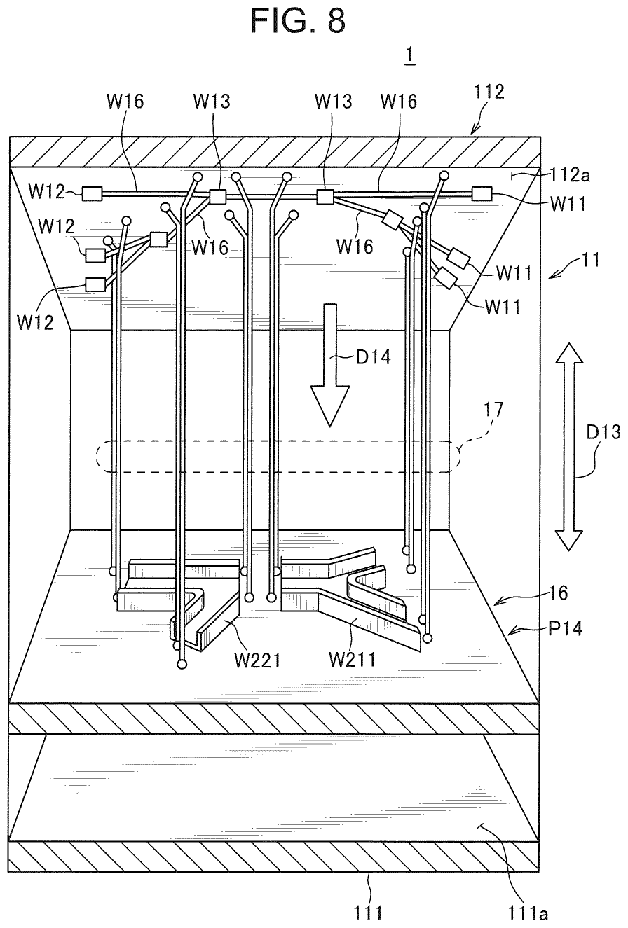

FIG. 7A and FIG. 7B are schematic views showing the exterior installation plate used for accommodating the electric wires with respect to the protector main body shown in FIG. 6, and FIG. 8 is a schematic view showing an electric-wire guide used for accommodating the electric wire with respect to the protector main body together with the exterior installation plate shown in FIG. 7A and FIG. 7B. It is noted that in FIG. 8, for making the figure easier to view, the illustrations of the sliding portion 12 and the base-end retaining portion 13 in the ceiling surface 112a are omitted.

As shown in FIG. 7A, according to the wire harness manufacturing apparatus 1, in the ceiling surface 112a of the ceiling-plate portion 112, the electric wire processing of forming the branch shape is performed by the formation of the tape winding portion W13 with respect to the electric wire W16. At this time, at the outside of the apparatus frame 11, the installation of the protector main body W211, W221 with respect to the exterior installation plate 16 as shown in FIG. 7B is performed. The exterior installation plate 16 is a plate member that is able to be taken in and out along the reference surface 111a to an insertion position P14 between the plurality of sliding portions 12 together with one or more base-end retaining portion 13 and the reference surface 111a of the bottom-plate portion 111. On the upper surface of this exterior installation plate 16, the protector main body W211, W221 is disposed to direct the groove opening as the accommodation side for the electric wire W16 upward. As described above, the installation of the protector main body W211, W221 to the exterior installation plate 16 is performed at the outside of the apparatus frame 11 manually by the worker, by an operation robot (not shown) or the like during the electric wire processing with respect to the electric wire W16 in the ceiling surface 112a. The exterior installation plate 16 to which the protector main body W211, W221 is installed is inserted to the above-described insertion position P14 in the apparatus frame 11. At the insertion position P14, the groove opening of the protector main body W211, W221 on the exterior installation plate 16 is in a state of facing the electric wire W16 that has been into the branch shape after the electric wire processing. In this state, when the sliding portion 12 and the base-end retaining portion 13 release the front-end connector W11 and the back-end connector W12, the electric wire W16 is unloaded downward and falls toward the exterior installation plate 16. At this time, the electric-wire guide portion 17 is used for causing the electric wire W16 to be accommodated inside from the groove opening of the protector main body W211, W221.

The electric-wire guide portion 17 is a member configured to guide the electric wire W16 to be accommodated in the protector main body W211, W221, wherein the electric wire W16 is disposed to be detachable between the exterior installation plate 16 and the sliding portion 12 and the base-end retaining portion 13 moving to the position in response to the branch shape. According to the present embodiment, the electric-wire guide portion 17 is a plurality of pairs of rod-shaped members as follows. Each electric-wire guide portion 17 connects the proximity of the electric wire W16 in the ceiling surface 112a where the sliding portion 12 and the base-end retaining portion 13 are provided and the proximity of the end portions of the protector main body W211, W221 in the exterior installation plate 16 in the up-down direction D13. One end of each electric-wire guide portion 17 is fixed in the ceiling surface 112a and the other end is fixed in the exterior installation plate 16. When the electric wire W16 is unloaded to fall downward, the electric wire W16 passing between each pair of electric-wire guide portion 17 is guided to the groove opening of the protector main body W211, W221 while keeping the branch shape and then accommodated therein. Thereafter, the electric-wire guide portion 17 is removed, and the exterior installation plate 16 together with the unloaded electric wire W16 are taken out to the outside of the apparatus frame 11. Then, at the outside, the protector cover W212, W222 is attached to the protector main body W211, W221, and as shown in FIG. 6, the wire harness W2 having the electric wire W16 with a protector has been completed.

According to the wire harness manufacturing apparatus 1 described above, it is possible to automatically manufacture the wire harness W1, W2 by performing the electric wire processing including stretching the electric wire W16 between the base-end retaining portion 13 and the sliding portion 12 to form the branch. At this time, regarding the electric wire W16 during the manufacturing, both ends thereof are in the state of being retained by the sliding portion 12 and the base-end retaining portion 13 at the ceiling height H11 from the reference surface 111a. Depending on the position of the sliding portion 12, the electric wire W16 may become slack, however, in that case, the electric wire W16 will hang downward due to its own weight such that it is possible to prevent the electric wire W16 from getting caught by the sliding portion 12 and the base-end retaining portion 13 at the ceiling height H11. Also, the electric-wire processing portion 14 performing the electric wire processing to the electric wire W16 is provided not to come into contact with the electric wire hanging downward such that it is also possible to prevent the electric wire W16 from getting caught by this electric-wire processing portion 14. Accordingly, according to the wire harness manufacturing apparatus 1 of this embodiment, it is possible to automatically manufacture the wire harness W1, W2 while preventing the electric wire W16 during the manufacturing from getting caught.

Here, according to the present embodiment, the sub-harness W1a are supplied between the sliding portion 12 and the base-end retaining portion 13. Then, the sliding portion 12 and the base-end retaining portion 13 retain the both ends of the electric wire W16 via the front-end connector W11 and the back-end connector W12 in the sub-harness W1a. According to this configuration, the electric wire W16 is supplied between the sliding portion 12 and the base-end retaining portion 13 in the state of the sub-harness W1a, and at this time, the delivery of the front-end connector W11 and the back-end connector W12 is performed from below as the reference surface 111a side. As a result, with regard to the supply of the sub-harness W1a as the preliminary stage of the harness manufacturing, it is performed in the state in which the electric wire W16 hangs downward such that it is possible to be performed in the state of preventing the electric wire W16 from getting caught by the sliding portion 12, the base-end retaining portion 13, and the electric-wire processing portion 14.

Also, according to the present embodiment, the sub-harness supply cart 15, that is able to retain the plurality of sub-harnesses W1a while being taken in and out to the supply position P11, and to be taken in to this supply position P11 to supply the plurality of sub-harnesses W1a, is provided in the wire-harness manufacturing apparatus 1. According to this configuration, by making the sub-harness supply cart 15 to retain the plurality of sub-harnesses W1a and to be taken to the supply position P11, when compared with a case in which the plurality of sub-harnesses W1a are supplied individually or the like, it is possible to make the supply to be efficient.

Also, according to the present embodiment, the sliding portion 12 moves to the connector receiving position P12 at the first-end side 1a when receiving the front-end connector W11 from the sub-harness supply cart 15. At this time, the sliding portions 12 line up in a row in the arrangement direction D12 at the connector receiving position P12, and the base-end retaining portions 13 line up in a row in the arrangement direction D12 at the first-end side 1a. When the sub-harness supply cart 15 is inserted to the supply position P11, the front-end connectors W11 and the back-end connectors W12 are detachably retained to be arranged so as to face these sliding portions 12 and the base-end retaining portions 13 in one-to-one correspondence. According to this configuration, the front-end connectors W11 and the back-end connectors W12 that are retained by the sub-harness supply cart 15 as the supply targets are lined up with respect to the sliding portions 12 and the base-end retaining portions 13 as the supply destinations in one-to-one correspondence such that it facilitates the delivery.

Also, according to the present embodiment, the sub-harness supply cart 15 ascends when it is taken in to the supply position P11. Due to this ascend, the sub-harness supply cart 15 presses the front-end connectors W11 and the back-end connectors W12 against the sliding portions 12 at the connector receiving position P12 and the base-end retaining portions 13 at the first-end side 1a to deliver them at once. According to this configuration, the front-end connectors W11 and the back-end connectors W12 are delivered at once due to the ascend of the sub-harness supply cart 15 such that it is possible to significantly reduce the operation time regarding the supply of the sub-harnesses W1a.

Also, according to the present embodiment, the sliding portions 12 and the base-end retaining portions 13 release the one end and the other end of the electric wires W16 that have passed the processing in the electric-wire processing portion 14 to make them to fall downward, the electric wires W16 are unloaded to the reference surface 111a side. According to this configuration, the unloading of the electric wires W1a that have passed the processing in the electric-wire processing portion 14 can be performed by only releasing the end portions in the sliding portions 12 and the base-end retaining portions 13, and it is unnecessary to set up a special jig or the like. As a result, it is possible to reduce the operation time and the apparatus cost regarding the unloading operation of the processed electric wires W16.

Also, according to the present embodiment, after the processing at the electric-wire processing portion 14, the sliding portions 12 moves to line up in a row in the arrangement direction D12 at the unloading position P13 at the first-end side 1a, and release the one end side of the electric wires W1a at this unloading position P13. According to this configuration, before the unloading, the sliding portions 12 approach the base-end retaining portions 13 at the first-end side 1a to line up in a row at the unloading position P13. As a result, the electric wires W16 as the unloading objects are folded and hang downward in a state in which the front-end connectors W11, together with the back-end connectors W12 are aligned. Due to the hanging down of such electric wires W16, during the unloading of the electric wires W16, it is possible to perform the unloading while preventing the electric wires W16 from getting caught by the structure objects on the ceiling surface 112a such as the sliding portions 12, the base-end retaining portions 13 and the like.

Also, according to the present embodiment, the wire harness manufacturing apparatus 1 includes the exterior installation plate 16 and the electric-wire guide portion 17. The exterior installation plate 16 as the exterior member on the upper surface is the member being taken in to the insertion position P14 in the state in which the protector main body W211, W221 configuring the front-end protector W21 and the back-end protector W22 are set such that the accommodation side of the electric wires W16 is directed upward. The electric-wire guide portion 17 is the member to guide the electric wires 16 falling downward due to the unloading to be accommodated in the protector main body W211, W221. According to this configuration, the attachment of the protector main body W211, W221 with respect to the electric wire W16 is performed by the setting of the protector main body W211, W221 to the upper surface of the exterior installation plate 16, the insertion of the exterior installation plate 16, and the guide for the falling electric wire by the electric-wire guide portion 17. Among these steps, the step performed by the operator, the robot arm and the like is the setting of the protector main body W211, W221 to the upper surface of the exterior installation plate 16. Such operation is much more efficient than directly attaching the protector main body W211, W221 to the electric wire W16 stretched at the predetermined height. Thereafter, the exterior installation plate 16 in which the protector main body W211, W221 has been set is taken in and the unloading of the electric wires W16 by the falling thereof is performed. During the unloading, by the guide of the electric-wire guide portion 17, the electric wire W16 is automatically accommodated at the inside of the protector main body W211, W221. In this manner, according to the above-described configuration, it is possible to improve the workability while necessarily minimizing the operations by the operator, the robot arm or the like to the setting of the protector main body W211, W221 to the upper surface of the exterior installation plate 16.

Also, according to the present embodiment, the electric-wire processing portion 14 includes the robot arm 141 and the processing mechanism 142. The robot arm 141 is disposed at the position not to be in contact with the electric wire W16 even if the electric wire W16 hangs down. The processing mechanism 142 is the mechanism that is detachably retained by the robot arm 141 to be carried to the workplace of the electric wire processing to perform the electric wire processing. This processing mechanism 142 stands by at the standby location 112c being adjacent to the movement route of the sliding portion 12 on the ceiling surface 112a at the ceiling height H11 until it is retained by the robot arm 141. According to this configuration, the robot arm 141 is provided at the position not to be in contact with the electric wire W16, and the processing mechanism 142 stands by in the standby location 112c at the ceiling height H11 before being retained by the robot arm 141. As a result, it is possible to effectively prevent the electric wire W16 in the state of hanging down from getting caught by either of the robot arm 141 or the processing mechanism 142.

Also, according to the present embodiment, in the standby are 112c, various types of the processing mechanism with different processing contents are standing by in the standby location 112c. The robot arm 141 selectively retains one of the processing mechanism 142 in response to the processing content to be executed from these various types of the processing mechanism 142. According to this configuration, it is possible to correspond to various electric wire processing while effectively preventing the electric wire W16 from getting caught by providing the various types of processing mechanism 142 in the standby location 112c at the ceiling height H11.

It is noted that the above-described embodiment merely shows a typical form of the wire harness manufacturing apparatus. The wire harness manufacturing apparatus is not limited thereto, and various modification can be implemented.

For example, according to the above-described embodiment, as an example of the wire harness as the manufacturing target, the wire harness W1 that is mounted and routed in the vehicle is shown as the example. However, the wire harness is not limited thereto and it may be a wire harness other than for use in the vehicle.

Also, according to the above-described embodiment, as an example of the wire harness as the manufacturing target, the wire harness W1, W2 that is schematically shown in FIG. 3, FIG. 6 is described as an example. However, the wire harness is not limited thereto, and as long as it has the branch shape, the specific number of branches, presence or absence, the type and the like of the exterior members are not critical.

Also, according to the above-described embodiment, as an example of the wire harness manufacturing apparatus, the wire harness manufacturing apparatus 1 in which the sub-harness W1a is supplied between the sliding portion 12 and the base-end retaining portion 13 is shown as an example. The sliding portion 12 and the base-end retaining portion 13 shown in this example retain the both ends of the electric wire W16 via the front-end connector W11 and the back-end connector W12 in the sub-harness W1a. However, the wire harness manufacturing apparatus is not limited thereto, an electric wire that is drawn from an electric wire reel rather than the sub-harness may be supplied between the sliding portion and the base-end retaining portion, and the sliding portion and the base-end retaining portion may directly retain the ends of the electric wire. In this case, a mechanism for connecting the ends of the electric wire retained by each portion to the connectors of the wire harness may be provided separately. However, according to the electric wire supply via the front-end connector W11 and the back-end connector W12 of the sub-harness W1a, as described above, it is possible to prevent the electric wire W16 from getting caught at the supply stage before the harness manufacturing.

Also, according to the above-described embodiment, as an example of the wire harness manufacturing apparatus, the wire harness manufacturing apparatus 1 including the sub-harness supply cart 15 for retaining and supplying the plurality of sub-harnesses W1a is described. However, the wire harness manufacturing apparatus is not limited thereto. In the wire harness manufacturing apparatus, for example, the plurality of sub-harnesses may be individually supplied by the operator, the robot arm or the like, for example. However, by using the sub-harness supply cart 15, as described above, it is possible to efficiently provide the plurality of sub-harnesses W1a.

Also, according to the above-described embodiment, as an example of the wire harness manufacturing apparatus, the wire harness manufacturing apparatus 1 in which the sliding portions 12 move to the connector receiving position P12 at the time of receiving the front-end connector W11 to line up in a row together with the base-end retaining portions 13 is described. Then, according to this wire harness manufacturing apparatus 1, the sub-harness supply cart 15 detachably retains the front-end connectors W11 and the back-end connectors W12 in the arranged state to face the sliding portions 12 and the base-end retaining portions 13 in one-to-one correspondence at the supply position P11. However, the wire harness manufacturing apparatus is not limited thereto. The wire harness manufacturing apparatus, for example, may be configured such that the arrangement of the sliding portion and the base-end retaining portion and the connector arrangement in the sub-harness supply cart at the supply position are not in specific correspondence. However, by making these arrangements in one-to-one correspondence, as described above, it is possible to facilitate the delivery of the front-end connector W11 and the back-end connector W12 to the sliding portion 12 and the base-end retaining portion 13.

Also, according to the above-described embodiment, as an example of the sub-harness supply cart, the sub-harness supply cart 15 that ascends when being taken in to the supply position P11, and presses the front-end connectors W11 and the back-end connectors W12 against the delivery destination to deliver them at once is described. However, the sub-harness supply cart is not limited thereto, and it may be configured such that the connector supply after being taken in to the supply position P11 is individually performed by the operator, the robot arm or the like. However, according to the configuration of pressing the connectors against the supply destination to deliver them at once due to the ascend of the sub-harness supply cart 15, as described above, it is possible to significantly reduce the time regarding the supply of the sub-harnesses W1a.

Also, according to the above-described embodiment, as an example of the wire harness manufacturing apparatus, the wire harness manufacturing apparatus 1 configured to unload the electric wire W16 by the electric wire falling downward due to the connector release at the sliding portion 12 and the base-end retaining portion 13 is described. However, the wire harness manufacturing apparatus is not limited thereto, and it may be configured to use an unloading jig to unload the electric wire. However, according to the configuration of unloading the electric wire W16 by releasing the connector to make the electric wire to fall downward, as described above, it is possible to reduce the operation time and the apparatus cost regarding the unloading operation of the processed electric wire W16.

Also, according to the above-described embodiment, as an example of the wire harness manufacturing apparatus, the wire harness manufacturing apparatus 1 in which the sliding portion 12 moves to the unloading position P13 to perform the release of the electric wire W16 after the processing at the electric-wire processing portion 14 is described. However, the wire harness manufacturing apparatus is not limited thereto, and for example, it may be configured that the sliding portion does not move from the position at the end of the electric wire processing to release the electric wire W16. However, by the sliding portion 12 moving to the unloading position P13 to release the electric wire W16 in the state in which the electric wire W16 hangs downward, as described above, during the unloading of the electric wire W16, it is possible to perform the unloading while preventing the electric wire W16 form getting caught by the structure objects on the ceiling surface 112a.

Also, according to the above-described embodiment, as an example of the wire harness manufacturing apparatus, the wire harness manufacturing apparatus 1 including the exterior installation plate 16 and the electric-wire guide portion 17 is described. However, the wire harness manufacturing apparatus is not limited thereto, and it may be configured that the exterior member is directly attached to the electric wire being stretched at the predetermined height by the operator, the robot arm or the like. However, by providing the exterior installation plate 16 and the electric-wire guide portion 17, as described above, it is possible to improve the workability thereof while necessarily minimizing the operations by the operator, the robot arm and the like. Also, according to the above-described embodiment, as an example of the exterior member, the front-end protector W21 and the back-end protector W22 including the protector main body W211, W221 and the protector cover W212, W222 are described. However, the exterior member is not limited thereto, and the specific form of the member is not limited as long as it has a cylindrical shape and can accommodate the electric wire inside from the lateral side intersecting the length direction. Examples of such exterior members include the corrugated tubes and the twisted tubes that can accommodate the electric wires through slits in the circumferential surface. Also, according to the above-described embodiment, as an example of the electric-wire processing portion, the electric-wire processing portion 14 including the robot arm 141 that is not in contact with the electric wire W16 that hangs downward and the processing mechanism 142 stands by at the standby location 112c until being retained by the robot arm 141 is described. However, the electric-wire processing portion is not limited thereto, the specific mechanism configuration is not limited, and for example, a robot arm with the processing mechanism as an integrated mechanism or the like may be configured as long as it is provided to not in contact with the electric wire. However, according to the electric-wire processing portion 14 including the robot arm 141 and the processing mechanism 142, as described above, it is possible to effectively prevent the electric wire W16 in the state of hanging downward from getting caught.

Also, according to the above-described embodiment, as an example of the processing mechanism and an example of the robot arm, the various types of processing mechanism 142 standing by at the standby location 112c and the robot arm 141 configured to selectively retain one processing mechanism 142 in response to the processing content are described. However, the processing mechanism and the robot arm are not limited thereto, and it may be configured that only one processing mechanism stands by at the standby location and the robot arm retains the one processing mechanism. However, according to the configuration in which the robot arm 141 selectively retains the one processing mechanism 142 among the various types of processing mechanism 142 at the standby location 112c, as described above, it is possible to correspond to various of electric wire processing while effectively preventing the electric wire W16 form getting caught.

### REFERENCE SIGNS LIST

1 wire harness manufacturing apparatus
1a first-end side
1b second-end side
11 apparatus frame
12 sliding portion
13 base-end retaining portion
14 electric-wire processing portion
15 sub-harness supply cart
16 exterior installation plate
17 electric-wire guide portion
111 bottom plate portion
111a reference surface
111b arm rail
112 ceiling-plate portion
112a ceiling surface
112b sliding rail
112c standby location
113 column portion
121, 131 rotation axis
141 robot arm
142 processing mechanism
151 bottom plate portion with wheels
151a wheel
152 front-end retaining ceiling plate portion
152a front-end connector cup
153 back-end retaining ceiling plate
153a back-end connector cup
154 cart column portion
D11 sliding direction
D12 arrangement direction
D13 up-down direction
D14 unloading direction
D111 stretching direction
D112 folding direction
H11 ceiling height
P11 supply position
P12 connector receiving position
P13 unloading position
P14 insertion position
W1, W2 wire harness
W1a, W2a sub-harness
W1b main wire portion
W1c intermediate wire portion
W11 front-end connector
W12 back-end connector
W13 tape winding portion
W14 exterior portion
W15 fixing clip
W16 electric wire
W21 front-end protector
W22 back-end protector
W131 tape
W141 corrugated tube
W211, W221 protector main body
W212, W222 protector cover

What is claimed is:

1. A wire harness manufacturing apparatus, comprising:
a plurality of sliding portions provided at a position at a predetermined height from a reference surface extending along a horizontal surface, the plurality of sliding portions each retaining one end side of at least one electric wire, configuring a wire harness having a branch shape, toward the reference surface side, and the plurality of sliding portions being configured to line up along an arrangement direction in the reference surface to be parallel to each other to perform a movement in a straight line along a sliding direction between a first-end side and a second-end side;
one or more base-end retaining portions provided at the first-end side as a base-end side of the movement in a straight line at the predetermined height to be immobile at least in the sliding direction, the base-end retaining portion being lined up in the arrangement direction to retain the other end side of at least one of the electric wire toward the reference surface side; and
an electric-wire processing portion as a mechanism portion configured to perform an electric-wire processing including a processing of selectively bundling the electric wires to form the branch shape with respect to the plurality of electric wires that are stretched between the one or more base-end retaining portions and the plurality of sliding portions by the plurality of sliding portions, each retaining the one end side of the electric wire, moving to a position in response to the branch shape between the first-end side and the second-end side, wherein the electric-wire processing portion is provided to not in contact with the electric wire even in a case in which the electric wire hangs downward due to the position of the sliding portion.

2. The wire harness manufacturing apparatus according to claim 1,
wherein the wire harness is configured by combing a plurality of sub-harnesses each being configured by one or more of the electric wires and two or more of connectors configured to both end portions of the electric wire respectively, and
between the sliding portion and the base-end retaining portion, the sub-harness is supplied by delivering the connector from a lower side as the reference surface side to the sliding portion and the base-end retaining portion, and the sliding portion and the base-end retaining portion are configurations to retain the both end portion of the electric wire via the connectors.

3. The wire harness manufacturing apparatus according to claim 2, further comprising a sub-harness supply cart as a cart which is able to be taken in and out along the reference surface to a supply position between the plurality of sliding portions and the one or more base-end retaining portions while retaining the plurality of sub-harnesses, and the sub-harness supply cart is inserted to the supply position to supply the plurality of sub-harnesses.

4. The wire harness manufacturing apparatus according to claim 3,
wherein the sliding portion is a configuration moving to a connector receiving position at the first-end side at the time of receiving the connector from the sub-harness supply cart, and
the sub-harness supply cart is a configuration, when being inserted to the supply position, detachably retaining the connectors of the plurality of sub-harnesses in a state of being lined up to face the one or more base-end retaining portions lining up in the arrangement direction at the first-end side and the plurality of sliding portions lining up in the arrangement direction at the connector receiving position in one-to-one correspondence.

5. The wire harness manufacturing apparatus according to claim 4, wherein the sub-harness supply cart is a configuration that ascends when being inserted to the supply position to press the connectors in the plurality of sub-harnesses against the one or more base-end retaining portions at the first-end side and the plurality of sliding portions at the connector receiving position to deliver at once.

6. The wire harness manufacturing apparatus according to claim 1, wherein the sliding portion and the base-end retaining portion retain the one end side and the other end side of the electric wire to be able to release, and release the one end side and the other end side of the electric wire that has been processed in the electric-wire processing portion to make them to fall down so as to unload the electric wire to the reference surface side.

7. The wire harness manufacturing apparatus according to claim 6, wherein after the processing in the electric-wire processing portion, the plurality of sliding portions moves to line up in a row in the arrangement direction at an unloading position at the first-end side to release the one end side of the electric wire at the unloading position.

8. The wire harness manufacturing apparatus according to claim 6,
wherein the wire harness is a configuration in which the electric wire being processed in the electric-wire processing portion is accommodated in an exterior member in a cylindrical shape and being able to accommodate the electric wire inside from a lateral side intersecting a length direction thereof, and
the wire harness further comprises:
an exterior installation plate as a plate member being able to be taken in and out along the reference surface to an insertion position between the plurality of sliding portions and the one or more base-end retaining portions and the reference surface, the exterior installation plate being inserted to the insertion position in a state in which the exterior member is set on a top surface thereof to direct an accommodation side of the electric wire upward; and
an electric-wire guide portion that is detachably provided between the sliding portion and the base-end retaining portion, moving to the position in response to the branch shape, and the exterior installation plate, and is configured to guide the electric wire falling down due to the unloading to make the electric wire to be accommodated in the exterior member.

9. The wire harness manufacturing apparatus according to claim 1,
wherein the electric-wire processing portion comprises:
a robot arm provided at a position not to be in contact with the electric wire even in a case in which the electric wire hangs downward; and
a processing mechanism being detachably retained by the robot arm and carried to a workplace of the electric-wire processing to perform the electric-wire processing, the processing mechanism standing by at a standby location being adjacent to a movement route of the sliding portion at the predetermined height until being retained by the robot arm.

10. The wire harness manufacturing apparatus according to claim 9,
wherein various types of the processing mechanism with different processing contents from each other stand by at the standby location, and
the robot arm selectively retains one of the processing mechanism among the various types of processing mechanism in response to the processing contents to be executed.
